(19) United States
(12) Patent Application Publication
(10) Pub. No.: US 2007/0295811 A1
(43) Pub. Date: Dec. 27, 2007

(54) Composite exit window

(76) Inventor: Thomas Wulff, North Patchogue, NY (US)

Correspondence Address: FAY KAPLUN & MARCIN, LLP, 15O BROADWAY, SUITE 702, NEW YORK, NY, 10038, US

(21) Appl. No.: 11/471,880

(22) Filed: Jun. 21, 2006

(51) Int. Cl. G06K 7/10

(52) U.S. Cl. 235/454

(57) ABSTRACT

Described is an optical device. The optical device comprises a housing, a scanning engine located within the housing, and a transparent exit window formed in the housing allowing light to pass from an exterior of the optical device to the scanning engine within the housing, the exit window having a glass layer coupled to a plastic layer, wherein the glass layer forms an exterior surface of the exit window and the plastic layer forms an interior surface of the exit window.

### BACKGROUND

Optical devices such as scanners and imagers are relied on for business and personal use in a wide variety of applications. These optical devices are often used in industrial, commercial, or retail environments where the potential for damage to the optical device is great. Rugged designs to extend the life and proper operation of the optical devices are preferable.

### SUMMARY OF THE INVENTION

The present invention relates to an optical device. The optical device comprises a housing, a scanning engine located within the housing, and a transparent exit window formed in the housing allowing light to pass from an exterior of the optical device to the scanning engine within the housing, the exit window having a glass layer coupled to a plastic layer, wherein the glass layer forms an exterior surface of the exit window and the plastic layer forms an interior surface of the exit window.

### DESCRIPTION OF THE DRAWINGS

FIG. 1 shows a perspective view of an optical device including a transparent exit window arrangement according to an exemplary embodiment of the present invention.

FIG. 2 shows a perspective view of the optical device of FIG. 1 with a top of a housing thereof removed to show the transparent exit window arrangement according to the exemplary embodiment of the present invention.

FIG. 3 shows a cross-sectional view of the optical device of FIG. 2 with the transparent exit window arrangement according to the exemplary embodiment of the present invention.

### DETAILED DESCRIPTION

The present invention may be further understood with reference to the following description and the appended drawings, wherein like elements are referred to with the same reference numerals. The exemplary embodiment of the present invention describes a system for a transparent exit window in an optical device. The exemplary embodiment of the transparent exit window is composed of glass on the outer side and plastic on the inner side. The use of the transparent exit window along with its advantages will be discussed in detail below.

The transparent exit window will be described with reference to an arrangement for a laser scanning device. However, those skilled in the art will understand that this device is exemplary only and that the exemplary transparent exit window may be applied to any optical device with a window, such as an image scanner. That is, in this description, the term “optical device” refers to any device that collects light for the purpose of collecting data such as a laser scanner, a bar code reader, an image scanner, a camera, a charge coupled device, etc. Also, those skilled in the art will understand that the term “transparent” refers to the ability of a material to pass, at least, light. It should be noted that the optical device may be mobile or stationary.

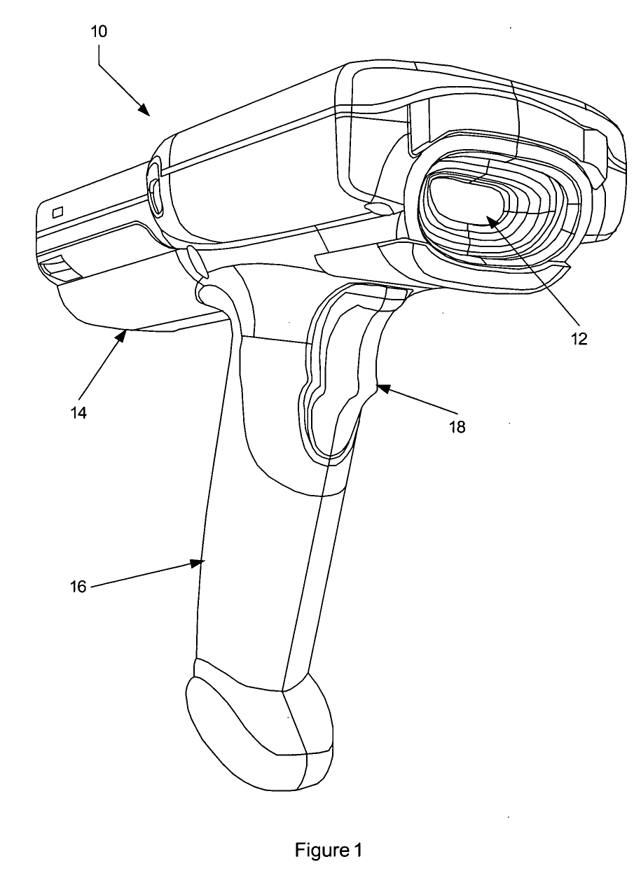

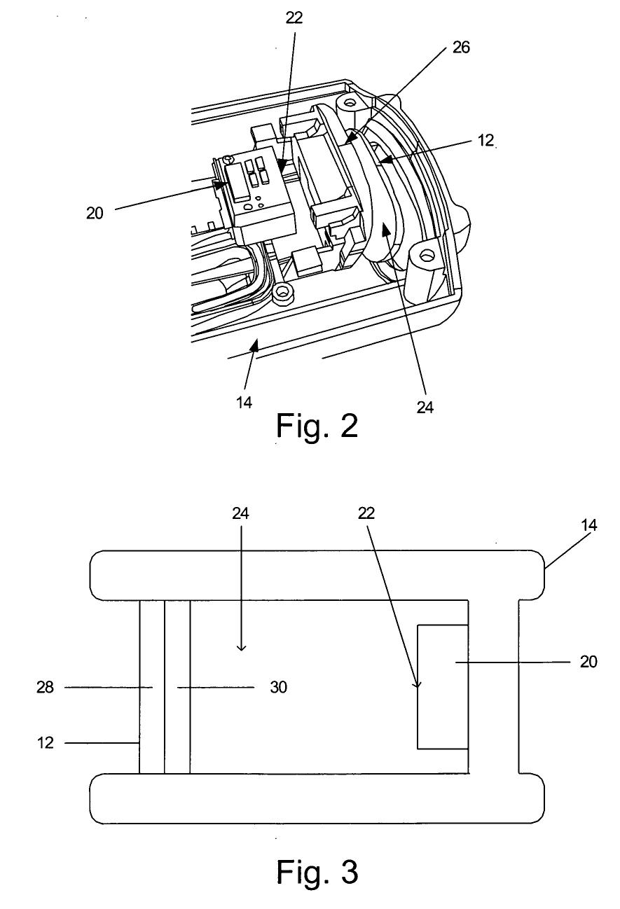

FIG. 1 shows an exemplary optical device 10, which in this embodiment is a bar code scanner, including a window 12 mounted in a housing 14 which includes, for example, a pistol grip 16 and a scanning actuator 18. As shown in FIG. 2, a known scanning engine 20 (e.g., a laser scanner) is mounted within the housing 14 along with supporting electronics, a battery, connectors, etc. As would be understood by those skilled in the art, the position of the scanning engine 20 relative to the window 12 is determined based on the properties of the scanning engine 20, the window 12 and the desired functionality of the device 10. Specifically, the optical properties of the window 12 and the scanning engine 20 dictate an optimal distance and angle between a forward end 22 of the scanning engine 20 and an inner face of the window 12 and, consequently, determining the size of a space 24 within the housing forward of the forward end 22 of the scanning engine 20. The optical properties of the window 12 will be discussed in detail below.

FIG. 3 shows a cross-sectional view of the optical device 10 with the transparent exit window 12 according to the exemplary embodiment of the present invention. The window 12 is a composite, transparent exit window constructed from a glass layer 28 and a plastic layer 30. When mounted in the housing 14, the glass layer 28 forms an external (or outer) surface of the window 12. The plastic layer 30 forms an internal (or inner) surface of the window 12. By creating the outer surface of the window 12 with glass, the window 12 has a scratch resilient outer surface, i.e., glass is generally less susceptible to scratches than plastic. As would be understood by those skilled in the art, the external surface of the window 12 is susceptible to scratches. These scratches may degrade the efficiency of the optical device 10, e.g., by refracting the incoming/outgoing light for the scanning engine 20. Thus, the glass layer 28 forming the outer surface of the window 12 provides a scratch resistance, thereby preventing degradation in the performance of the optical device due to scratches on the exit window 12.

However, while glass is scratch resistant, it is also fragile and subject to breakage, e.g., for example, if the optical device 10 were dropped. The breaking glass may damage the scanning engine 20 or other components in the housing 14 and may cause injury to the user of the optical device 10. Thus, the window 12 also includes the plastic layer 30 to reinforce and strengthen the glass layer 28. By creating the inner surface of the window 12 with the plastic layer 30, the window 12 has higher impact strength. As would be understood by those skilled in the art, the rugged plastic layer 30 should be placed toward the scanning engine 20 to prevent damage. With this transparent exit window arrangement, the window 12 provides a scratch resilient outer side (glass) to maintain a clear surface for the scanning engine 20 while providing a sturdy inner side (plastic) to maintain a strong surface to protect the scanning engine 20 and other internal components of the optical device 10. Those skilled in the art will understand that a shade of the window 12 may be clear or colored and does not affect the transparent properties of the window 12.

Due to the window 12 having a composite nature and the specific refractive index of the composite window, the distance between the forward end 22 of the scanning engine 20 and an inner surface of the window 12 may require modification. The window 12 will exhibit a unique refractive index based on several factors discussed below. Refraction is a change in direction of a light wave due to the change in velocity when the light wave passes from one medium to another, each exhibiting a different refractive index. The refractive index is a factor used to determine the refractive angle of a light wave relative to a standard refractive angle in a vacuum. Thus, in the present invention, several changes in mediums need be considered.

As discussed above, the window 12 comprises an outer glass layer 28 and an inner plastic layer 30. In a preferred embodiment of the present invention, the glass layer 28 is coupled to the plastic layer 30 using a transparent adhesive. The glass layer 28 may be, for example, annealed or tempered glass that is preferably thin and flexible. The plastic layer 30 may be, for example, a plastic substrate or any rugged, transparent polymer. The adhesive may be, for example, cellulose, polyurethane, or polyvinyl butyral. It should be noted that the examples cited for the glass layer 28, the plastic layer 30, and the adhesive are exemplary only and that other transparent materials may be used. It should also be noted that the use of an adhesive to couple the glass layer 28 and the plastic layer 30 is exemplary only and that other manners of coupling the plastic layer 30 and the glass layer 28 may be used. For example, the glass layer 28 may be coupled with the plastic layer 30 with the housing 14 holding each layer individually. With such an arrangement, there may exist another space between the layers. In another example, the glass layer 28 may be over-molded with the plastic layer 30. Those skilled in the art will understand that in such an assembly, no adhesive or space may exist and no adjustments to the housing 14 is necessary.

In this exemplary embodiment, the laser light from the scanning engine 20 first passes through the space 24. The space 24 is preferably air. Assuming that the medium with which the laser light enters after exiting the window 12 is substantially similar air (e.g., similar densities), the laser light enters that medium at the same angle at which it left the scanning engine 20. It should be noted that the space 24 being air is exemplary only and that other methods may be employed to fill the space 24, such as a vacuum or a liquid suspension. Depending on the composition of the space 24, the device 10 must take into consideration the refractive index of the space 24.

Once the laser light passes through the space 24, the laser light must pass through the window 12. The exemplary embodiment of the window 12 comprises three layers: glass layer 28, adhesive/space layer, and plastic layer 30. As discussed above, the plastic layer 30 forms an inner surface facing the scanning engine 20. Thus, the laser light first passes through the plastic layer 30. Then, the laser light passes through an adhesive or a space. Finally, the laser light passes through the glass layer 28. As would be understood by those skilled in the art, depending on the composition of each layer, the refractive index of each is considered in constructing the device 10.

It should also be noted that the refraction of a light wave is also dependent on the thickness of the medium with which it passes. For example, a thin medium would not refract a light wave as much as a thick medium. Thickness is of importance when determining the thickness of the layers for the window 12. For example, as discussed above, in a preferred embodiment of the window 12, the glass layer 28 is thin and flexible. The glass layer 28 is primarily used as a scratch resilient, not for its ruggedness. Thus, the glass layer 28 may be relatively thin so there is less chance of the glass layer 28 breaking. On the other hand, in order to provide adequate protection to the scanning engine 20, a relatively thick plastic layer 30 may be utilized. Therefore, the respective refractive indexes also consider the thicknesses of the layers in addition to the distance of the window 12, as discussed above.

In consideration of the refraction indexes, the positioning of the layers, such as angling, may be modified to correct any refraction of the laser light from the scanning engine 20. It should be noted that the modification to the positioning is only exemplary and that other methods exist to correct any refraction. For example, the scanning engine 20 may be placed at an angle. In another example, mirrors may be incorporated in the laser light path to correct any refraction by placing them in strategic positions. In a third example, the layers may exhibit a curved perimeter, functioning similarly to the lens of an eye.

It should also be noted that while the exemplary embodiment has been described with reference to a glass layer and a plastic layer, other materials may be used. For example, there may be a scratch resistant polymer material or natural material that may be used in place of the glass layer that performs the same functions as the glass layer. Moreover, the exit window is not limited to two layers. Because of the refractive indexes of certain materials, it may be effective to have a three (or more) layer window. The multiple layers may be used in conjunction with each other to correct refraction of the individual layers.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An optical device, comprising:
a housing;
a scanning engine located within the housing; and
a transparent exit window formed in the housing allowing light to pass from an exterior of the optical device to the scanning engine within the housing, the exit window having a glass layer coupled to a plastic layer, wherein the glass layer forms an exterior surface of the exit window and the plastic layer forms an interior surface of the exit window.

2. The optical device of claim 1, wherein a transparent adhesive couples the glass layer to the plastic layer.

3. The optical device of claim 2, wherein the adhesive is one of a cellulose adhesive, a polyurethane adhesive, and a polyvinyl butyral adhesive.

4. The optical device of claim 1, wherein the plastic layer over-molds the glass layer.

5. The optical device of claim 1, wherein the glass layer is one of a tempered glass and an annealed glass.

6. The optical device of claim 1, wherein the plastic layer has a first thickness and the glass layer has a second thickness.

7. The optical device of claim 6, wherein the first thickness is greater than the second thickness.

8. The optical device of claim 1, wherein the plastic layer is one of a plastic substrate and a transparent polymer.

9. The optical device of claim 1, wherein the exit window is mounted within the housing to compensate for a refraction of light through the exit window.

10. The optical device of claim 9, wherein the refraction compensation provides a maximum amount of light to reach the scanning engine.

11. The optical device of claim 1, wherein the scanning engine is one of a laser scanner, an imager, a camera, and a charge coupled device.

12. The optical device of claim 1, wherein the transparent exit window is one of cleared and colored.

13. A transparent exit window for an optical device, comprising:
a glass layer forming an external surface of the exit window; and
a plastic layer coupled to the glass layer, the plastic layer forming an internal surface of the exit window.

14. The transparent exit window of claim 13, wherein a non-coupled side of the plastic layer forming the inner surface faces toward a scanning engine of the optical device.

15. The transparent exit window of claim 13, wherein the glass layer is one of an annealed glass and a tempered glass.

16. The transparent exit window of claim 13, wherein the plastic layer is one of a plastic substrate and a transparent polymer.

17. The transparent exit window of claim 13, wherein a transparent adhesive couples the glass layer to the plastic layer.

18. The transparent exit window of claim 17, wherein the adhesive is one of a cellulose adhesive, a polyurethane adhesive, and a polyvinyl butyral adhesive.

19. The transparent exit window of claim 13, wherein the plastic layer over-molds the glass layer.

20. The transparent exit window of claim 13, wherein the plastic layer has a first thickness and the glass layer has a second thickness.

21. The transparent exit window of claim 20, wherein the first thickness is greater than the second thickness.

22. The transparent exit window of claim 13, wherein the transparent exit window is one of clear and colored.

23. An optical device, comprising:
a housing;
an optical means for one of emitting light beams and collecting light beams, the optical means being located within the housing; and
a window means mounted in the housing allowing the one of the emitted light beams to pass from within the housing to outside the housing and the one of the collected light beams to pass from outside the housing to within the housing, the window means having a first layer and a second layer formed of different materials.

24. The optical device of claim 23, wherein the first layer is formed from glass and the second layer is formed from plastic.
